(19) United States
(12) Patent Application Publication
(10) Pub. No.: US 2015/0345520 A1
(43) Pub. Date: Dec. 3, 2015

(54) HYDRAULIC CYLINDER WITH END POSITION DAMPING

(71) Applicant: KOMATSU MINING GERMANY GMBH, Düsseldorf (DE)

(72) Inventors: Henry Schwarz, Monheim (DE); Christian Hess, Bochum (DE); Oliver Martens, Marl (DE)

(73) Assignee: KOMATSU MINING GERMANY GMBH, Düsseldorf (DE)

(21) Appl. No.: 14/649,303

(22) PCT Filed: Nov. 12, 2013
(86) PCT No.: PCT/DE2013/000693

§ 371 Date: Jun. 3, 2015

(30) Foreign Application Priority Data
Dec. 4, 2012 (DE) 10 2012 024 155.0

(51) Int. Cl. F15B 15/22; F15B 11/048

(52) U.S. Cl. CPC F15B 15/224; F15B 11/048; F15B 2211/755

(57) ABSTRACT

A hydraulic cylinder with end position damping includes at least one cylinder in which there is arranged at least one piston which is connected to at least one piston rod and can be moved in the axial direction, wherein the cylinder is subdivided by the piston into a piston side and a rod side and the hydraulic oil necessary for actuating the piston is pumped by a hydraulic pump via inlet and outlet lines through inlet and outlet openings provided on the cylinder, wherein the cylinder is assigned a mechanical prethottling via which, during the movement of the piston, the hydraulic oil can be discharged on the rod side through a first bore until the piston, during its movement, closes the first bore and the hydraulic oil is thus discharged through a second bore, wherein, at a preset pressure, the mechanical prethrottling means forces the hydraulic pump into an electronically regulated pressure cutoff function which reduces the delivery rate of the hydraulic oil and the piston can be moved into its end position in a braked manner.

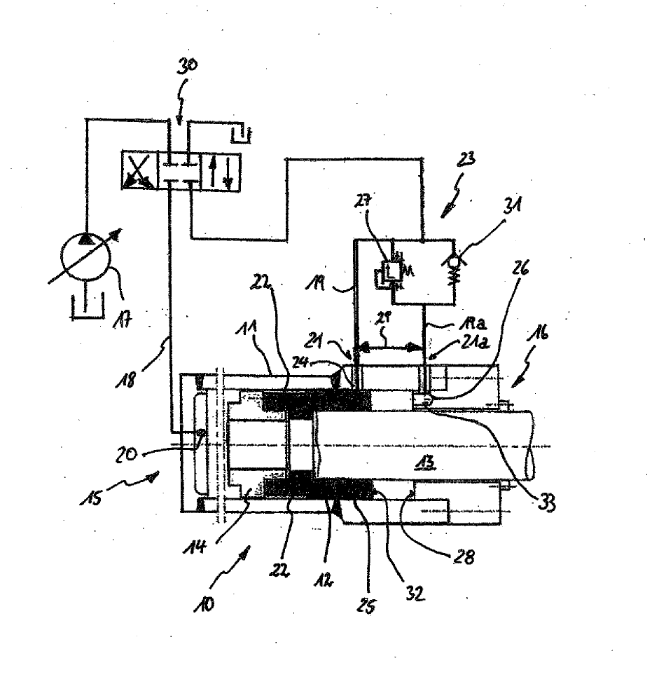

The present invention relates to a hydraulic cylinder with end position damping including at least one cylinder in which at least one piston is arranged that is connected to at least one piston rod and is displaceable in axial direction, wherein the piston divides the cylinder into a piston side and a piston-rod side and the hydraulic oil, required for actuation of the piston, is pumped from a hydraulic pump via inlet and outlet lines through inlet and outlet bores provided on the cylinder. The invention also relates to a shovel excavator having the hydraulic cylinder according to the invention.

End position damping is required for numerous machines and devices, wherein masses in motion have to be decelerated within defined standards. Thus end position damping ensures a soft deceleration of the hydraulic cylinder's speed at both of its end positions or also only at one end position in order to prevent damage to the piston or the respective end position of the chamber due to a high velocity impact of the piston. This is required because the systems for agricultural and construction machines not only have to meet high standards concerning durability during operation, but also increased functionality and in some cases health-relevant demands for comfort are considered imopeningant. High performance machines therefore require means that are able to absorb impacts and vibrations so as to efficiently protect humans and machines from overload. This is also intended to reduce noise pollution of the environment.

For this purpose dampers are known from the state of the art that operate based on a throttling of the fluid flow. Thereby, the kinetic energy resulting from the movement is converted into heat. The kinetic energy E as the product of all masses m acting on the piston rod and the stroke speed v at the beginning of the damping should not exceed the working volume W of the damping. It is generally known that this may be realized at the end positions by means of additions to the hydraulic cylinder having damping pistons with a smaller cross-section.

For instance, a piston or a tappet seals an outlet opening that is provided for drainage of hydraulic oil, as soon as the piston in the hydraulic cylinder is fully retracted or extended. Thereby, the hydraulic oil is forced to flow out of the cylinder chamber through a bypass that has a smaller cross-section than the outlet opening. The cross-section of the bypass is usually adjustable through a grub screw. Hereby, the cylinder is significantly slowed down and damped until reaching its end position.

These end position damping systems have proven their worth; however, they have the disadvantage that end position damping is achieved through additional components in and on the hydraulic cylinder. Furthermore, the adjustability and the calibration of the end position damping through grub screws or comparable means does not function entirely without difficulties due to the fact that an over- or underdamping may cause damage to the hydraulic cylinder. Additionally, electrical measuring technology is used in order to prevent the piston to impact the mechanical stops at full speed. The overall system may suffer considerable damage in the case of failure of the components that have been additionally included in the cylinder.

It is therefore an object of the present invention to provide a hydraulic cylinder with a self-regulating, electronic/hydraulic end position damping by which the aforementioned disadvantages may be remedied.

This object is achieved by the features set forth in claim 1, in particular in that a mechanical pre-throttling is assigned to the cylinder, via which pre-throttling the hydraulic oil can be discharged through a first bore during displacement of the piston until the piston, during its displacement, closes the first bore and the hydraulic oil is thus discharged through a second bore, from where it is conducted to a pressure relief valve that forces the hydraulic pump at a preset pressure into an electronically regulated pressure cut-off function that reduces the delivery rate of the hydraulic oil and the piston can be moved into its end position in a decelerated manner. Hereby, a damping of the piston's impact at the end of its travel path within the cylinder is achieved, which enables a simple and robust end position damping without requiring further components within the cylinder. Through the constructive arrangement on the piston and on the cylinder and the addition of two valves to the cylinder hydraulics, a self-regulating electronic/hydraulic end position damping is achieved.

In an advantageous embodiment of the hydraulic cylinder according to the invention, it is provided to configure the pre-throttling as a pressure relief valve and to connect it to the hydraulic pump through a hydraulic line and a (4/3) way control valve with a blocking center position.

In a further particularly advantageous embodiment of the hydraulic cylinder according to the invention, the pre-throttling is connected to the first bore and the second bore via hydraulic lines and the first bore is closed by the piston skirt when the piston moves to the end position of the piston rod side, wherein during the movement of the piston the piston head is moved in front of the second bore with a residual stroke remaining, so that the second bore is not closed by the piston head.

In a further particularly advantageous embodiment of the hydraulic cylinder according to the invention, the first bore is arranged spaced apart from the second bore so that the distance between the first and the second bores corresponds to the path the piston travels during the time required by the hydraulic pump to switch from a maximum feed rate to a minimum feed rate.

In a further embodiment of the hydraulic cylinder according to the invention, the bores are arranged on the hydraulic cylinder radially outwardly in the region of the piston rod side. It is also conceivable that the second bore—as opposed to the first bore—is embedded parallel to the piston rod at the end position and is guided radially outwardly through a connection in the region of the piston rod side.

It is provided to arrange the end position damping in particular within a hydraulic cylinder, which is in particular designed as a flap cylinder. In a further advantageous embodiment the flap cylinder is assigned to a shovel excavator. The end position damping according to the invention may be provided in a variety of hydraulic cylinders for hydraulic machines. These are expressly not limited to a flap cylinder.

A further object of the present invention is to provide a shovel excavator which includes the hydraulic cylinder according to the invention.

In the following, the invention is explained in more detail by way of an exemplary embodiment with reference to the enclosed drawing. The sole FIGURE shows:

FIG. a schematic sectional view through the hydraulic cylinder according to the invention, to which a 4/3 way control valve with a center blocking position with connected hydraulic pump is assigned, which valve is connected to the piston side and the piston rod side of the hydraulic cylinder via lines, wherein a mechanical prethrottling is arranged in the line of the piston rod side which is formed by a pressure relief valve and a non-return valve.

As shown in the sole FIGURE, the hydraulic cylinder 10 essentially consists of a cylinder 11 within which a piston 12 is arranged that is connected to a nut 14. The piston 12 is moveable in axial direction, wherein the cylinder 11 is divided by the piston 12 into a piston side 15 and a piston rod side 16. The piston side 15 is sealed against the piston rod side by a gasket 22, which is arranged radially outwardly on the piston 12. The hydraulic oil required to actuate the piston 12 is pumped by a hydraulic pump 17 via inlet- and outlet lines 18 and 19 and 19a through, inlet 20 and outlet openings 21, 21a.

The cylinder 11 is assigned a mechanical pre-throttling 23. Via the mechanical pre-throttling, the hydraulic oil can be discharged on the piston rod side 16 through a first bore 24 during the movement of the piston 12 until the piston 12 closes the first bore 24 with its piston skirt 25. The hydraulic oil is slowly throttled and then discharged through a second bore 26, from where it is conducted to a pressure relief valve 27 as component of the pre-throttling 23. The second bore 26 is provided in the area of the end position 28 at the piston rod side 16 of the hydraulic cylinder 10, where it is connected via a opening 33 to the end position 28. Hereby, the piston 12 may be moved into direct proximity of the end position 28 (with a residual stroke remaining) so that the entire hydraulic oil on the piston rod side 16 can be drained through the outlet opening 21a which is assigned to the second bore 26.

At a preset pressure the pressure relief valve 27 forces the hydraulic pump 17 into an electronically regulated pressure cut-off function. This means that the hydraulic pump 17 only operates with a low delivery rate on the piston side 15. This means that the pressure remains constant and only the delivery rate changes.

The delivery rate of the hydraulic oil on the piston side 15 is reduced by the pressure cut-off function and the piston 12 thus can be moved into its end position 28 on the piston rod side 16 in a decelerated manner. Hereby the pressure relief valve 27 is connected via the hydraulic line 19 for example with a (4/3) way control valve 30 (with center blocking position) to the hydraulic pump 17.

As the FIGURE also shows, the first bore 24 is arranged at a distance 29 to the second bore 26. The distance 29 between the first bore 24 and the second bore 26 corresponds to the path the piston 12 travels in the time required by the hydraulic pump 17 to switch from a maximum delivery rate to a minimum delivery rate. The mechanical pre-throttling 23 furthermore has a non-return valve 31. The non-return valve 31 ensures that the hydraulic oil, when flowing out of the opening 21 via the bore 26 into the outlet line 19a, can flow into the pressure relief valve 27 and is not directly pushed into the outlet line 29. In addition, the non-return valve 31 supopenings the return movement. This means that the non-return valve 31 opens in case of a reversal of flow and enables a pressure-free (i.e. low-loss) filling and return movement of the piston 12 in the cylinder 11. This may be associated with the opening of a flap on a shovel excavator (not shown).

### LIST OF REFERENCE SIGNS

10 hydraulic cylinder
11 cylinder
12 piston
13 piston rod
14 nut
15 piston side
16 piston rod side
17 hydraulic pump
18 inlet line
19 outlet line
20 inlet opening
21, 21a outlet opening
22 gasket
23 pre-throttling
24 first bore
25 piston skirt
26 second bore
27 pressure relief valve
28 end position
29 gap
30 directional control valve
31 non-return valve
32 piston head
33 opening

What is claimed:

1-10. (canceled)

11. A hydraulic cylinder with an end position damping, comprising:
a cylinder;
a piston arranged in the cylinder and connected to a piston rod, said piston dividing the cylinder into a piston side and a piston-rod side and being moveable in an axial direction in the cylinder;
a hydraulic pump, said piston being actuated by hydraulic oil pumped by the hydraulic pump via inlet and outlet lines through inlet and outlet openings provided on the cylinder; and
a mechanical pre-throttling assigned to the cylinder, wherein during movement of the piston into an end position of the piston, hydraulic oil present on the piston rod side is dischargeable via the mechanical pre-throttling through a first bore provided in the cylinder, until the piston closes the first bore whereupon the hydraulic oil is discharged through a second bore provided in the cylinder, wherein at a preset pressure of the hydraulic oil the mechanical pre-throttling forces the hydraulic pump into an electronically regulated pressure cut-off function, which reduces a delivery amount of the hydraulic oil thereby enabling movement of the piston into the end position in a braked manner.

12. The hydraulic cylinder of claim 11, wherein the pre-throttling is constructed as a pressure relief valve and is operatively connected to the hydraulic pump via a hydraulic line and a directional control valve with blocking center position.

13. The hydraulic cylinder of claim 12, wherein the pre-throttling is connected to the first bore and the second bore via hydraulic lines, and wherein during movement of the piston into the end position, the first bore is closable by a piston skirt of the piston and the second bore is closable by a piston head of the piston.

14. The hydraulic cylinder of claim 12, wherein the pre-throttling is connected to the first bore and the second bore via hydraulic lines, wherein the first bore is closable by a piston skirt of the piston, and wherein a piston head of the piston during the movement of the piston into the end position on the piston rod side is moveable into a position in front of the second bore at which a residual stroke remains in a direction toward the end position, said second bore being assigned to the end position

15. The hydraulic cylinder of claim 11, wherein the first bore and the second bore are spaced apart by a distance, said distance corresponding to a distance the piston travels during a time required by the hydraulic pump to switch from a maximum delivery rate to a minimum delivery rate.

16. The hydraulic of claim 15, wherein the first bore and the second bore are arranged radially outwardly on the cylinder in a region of the piston rod side.

17. The hydraulic of claim 15, wherein the first bore is arranged radially outwardly on the cylinder in the region of the piston rod side, wherein a connection is embedded parallel to the piston rod, said connection being assigned to the second bore in the end position, said second bore being guided radially outwardly on the cylinder in the region of the piston side via the connection.

18. The hydraulic cylinder of claim 11, wherein the hydraulic cylinder is assigned to a shovel excavator.

19. The hydraulic cylinder of claim 11, wherein the end position damping is assigned to a hydraulic cylinder which is constructed as a dump cylinder.

20. A shovel excavator, comprising the hydraulic cylinder of claim 11.
